(19) United States
(12) Patent Application Publication
(10) Pub. No.: US 2026/0357741 A1
(43) Pub. Date: Nov. 12, 2026

(54) SYSTEM AND METHOD FOR HEATING AN INLET OF A FORCED INDUCTION COMPRESSOR

(71) Applicant: INNIO Waukesha Gas Engines Inc., Waukesha, WI (US)

(72) Inventors: Lorne Eugene Nix, Waukesha, WI (US); Michael Url, Neufahrn (DE)

(21) Appl. No.: 19/201,898

(22) Filed: May 7, 2025

(51) Int. Cl. F02B 37/16; F02B 29/04; F02D 41/00; F02M 31/04

(52) U.S. Cl. CPC F02B 37/16; F02B 29/0412; F02B 29/0493; F02D 41/0007; F02M 31/042

(57) ABSTRACT

A system includes a forced induction system configured to couple to a reciprocating engine. The forced induction system includes a compressor and a first heat exchanger disposed downstream of the compressor. The forced induction system also includes a compressor bypass conduit configured to direct a compressor bypass flow from a bypass location disposed downstream from the first heat exchanger to a return location upstream from the compressor. The forced induction system also includes a first conduit configured to direct a first portion of a compressor discharge flow from a first location between the compressor and the first heat exchanger to the compressor bypass conduit. The first portion of the compressor discharge flow is configured to add heat to the compressor bypass flow to increase a temperature at an inlet of the compressor.

### BACKGROUND

The subject matter disclosed herein relates to heating an intake flow of a compressor of a forced induction turbocharger or supercharger and, more particularly, to proportionally mixing a plurality of portions of a discharged flow in a compressor bypass conduit to heat the intake flow.

For systems that use exhaust gas recirculation (EGR) and compressor bypass valve (CBV) recirculation, a humidity of an intake flow into the compressor may be elevated due to the combustion products of water in the in the exhaust gas. Unfortunately, due to certain environmental factors such as ambient temperature, ambient pressure, and ambient humidity the elevated humidity at the inlet of the compressor increases the likelihood of condensate forming in and/or around the inlet of the compressor, which could potentially lead to degradation of the compressor in the long term. Accordingly, systems and methods for mitigating the formation of condensate at the inlet of the compressor are desired.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In certain embodiments, a system includes a forced induction system configured to couple to a reciprocating engine. The forced induction system includes a compressor and a first heat exchanger disposed downstream of the compressor. The forced induction system also includes a compressor bypass conduit configured to direct a compressor bypass flow from a bypass location disposed downstream from the first heat exchanger to a return location upstream from the compressor. The forced induction system also includes a first conduit configured to direct a first portion of a compressor discharge flow from a first location between the compressor and the first heat exchanger to the compressor bypass conduit. The first portion of the compressor discharge flow is configured to add heat to the compressor bypass flow to increase a temperature at an inlet of the compressor.

In certain embodiments, a system includes a forced induction system configured to couple to a reciprocating engine. The forced induction system includes a compressor and a first heat exchanger disposed downstream of the compressor. The forced induction system also includes a compressor bypass conduit configured to direct a compressor bypass flow from a bypass location disposed downstream from the first heat exchanger to a return location upstream from the compressor. The forced induction system also includes an exhaust gas recirculation (EGR) conduit extending to an EGR location upstream from the compressor. The forced induction system also includes one or more first conduits configured to direct a first portion of a compressor discharge flow from one or more first locations between the compressor and the first heat exchanger to the compressor bypass conduit, the EGR conduit, or a combination thereof. The first portion of the compressor discharge flow is configured to adjust a temperature at an inlet of the compressor.

In certain embodiments, a method includes directing a compressor bypass flow from a bypass location disposed downstream from an heat exchanger to a return location upstream from a compressor of a turbocharger. The method also includes directing a first portion of a compressor discharge flow output by the compressor from a first location between the compressor and the heat exchanger to the compressor bypass conduit. The first portion of the compressor discharge flow is configured to add heat to the compressor bypass flow to increase a temperature at an inlet of the compressor.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a schematic diagram of an embodiment of an engine driven power generation system, in accordance with aspects of the present disclosure;

FIG. 2 is a schematic diagram of an embodiment of an engine driven power generation system having a plurality of forced induction systems in series, in accordance with aspects of the present disclosure;

FIG. 3 is a schematic diagram of an embodiment of the engine driven power generation system having a plurality of conduits interspersed between a compressor and a plurality of heat exchangers, in accordance with aspects of the present disclosure;

FIG. 4 is a schematic diagram of an embodiment of the engine driven power generation system having a plurality of compressors and a plurality of conduits interspersed between the plurality of compressors and a plurality of heat exchangers, in accordance with aspects of the present disclosure; and

FIG. 5 is a flowchart of an example process of operating the engine driven power generation system, in accordance with aspects of the present disclosure.

### DETAILED DESCRIPTION

One or more specific embodiments of the present subject matter will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present disclosure are directed to monitoring a temperature of an inlet of a compressor of a forced induction system (e.g., turbocharger system, supercharger system, etc.) and controlling one or more valves (e.g., compressor bypass or recirculation valves) downstream of the compressor based on a comparison of the temperature to a threshold temperature. The threshold temperature may be based on a dew point temperature for conditions at the inlet of the compressor. For example, the threshold temperature may be a percentage or offset temperature (e.g., 10, 20, 30, 40, or 50 degrees Celsius) above the dew point temperature. The dew point temperature may vary depending on a gas composition (e.g., air, exhaust gas, etc.), a pressure, and/or other conditions at the inlet of the compressor. In certain embodiments, the threshold temperature may be set at a fixed value based on various expected conditions at the inlet of the compressor and/or a variable value depending on sensor measurements of the pressure, gas composition, humidity, etc. at the inlet of the compressor. Accordingly, any discussion of control based on temperature and temperature thresholds in the present application are intended to include such fixed and variable values in the embodiments discussed in detail below. As disclosed herein, the forced induction system may include one or more heat exchangers disposed downstream of the compressor. The forced induction system also includes a plurality of conduits that fluidly connect the outlet of the compressor and/or the outlets of the heat exchangers to a compressor bypass conduit that feeds back to the inlet of the compressor. The conduits may have varying diameters so that a mixture of discharged flows having different temperatures will mix in the compressor bypass conduit according to a predetermined proportion, thereby maintaining the temperature at the inlet of the compressor within the threshold temperature value and mitigating condensation from forming at the inlet of the compressor.

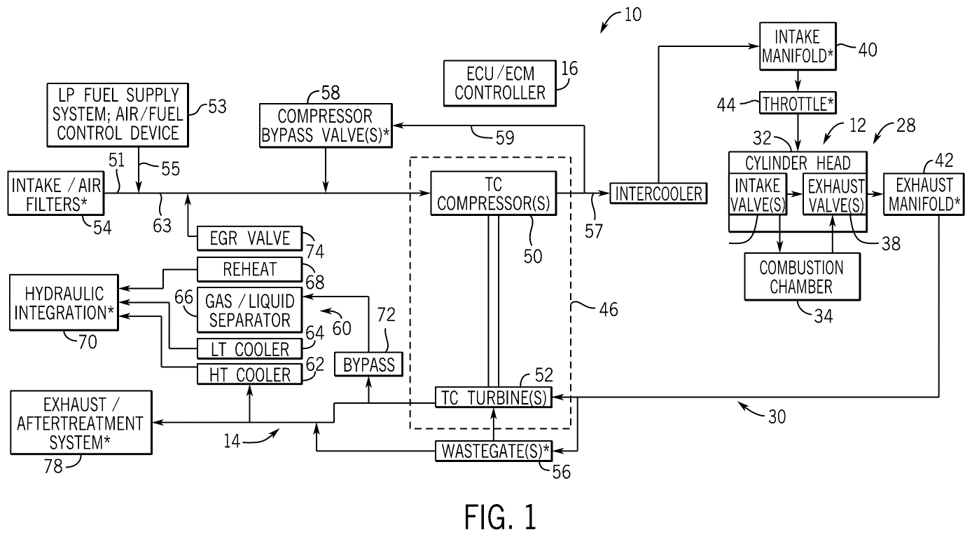

FIG. 1 is a schematic diagram of the engine driven power generation system 10 utilizing a low pressure loop EGR system (e.g., exhaust gas is diverted from downstream of the turbine of the turbocharger (TC) and reintroduced into the intake system before the compressor of the turbocharger (TC)). As discussed below, certain embodiments of the system 10 include various flow controls to bypass or recirculate a portion of a compressor discharge flow to a flow path entering an inlet of a compressor 50, thereby adjusting a compressor inlet temperature and inhibiting condensation at the inlet. Various components of the system 10 illustrated in FIG. 1, although illustrated as multiple components, may be shared across engine cylinder banks as indicated by asterisks. As depicted, the system 10 includes an engine 12 having multiple cylinder banks 28 and an EGR circuit 30. As depicted, the system 10 includes one EGR circuit 30, although the number of EGR circuits 30 may vary (e.g., 2, 3, 4, or more). Each combustion chamber 34 includes a respective cylinder head 32. Each cylinder head 32 includes multiple assemblies including a respective piston disposed within a respective cylinder (not shown). Fuel is provided to a combustion chamber 34 in each cylinder while an oxidant (e.g., air) is provided to the combustion chamber 34 via an intake valve(s) 36 where combustion occurs and an exhaust valve(s) 38 controls discharge of exhaust from the engine 12. Each cylinder bank 28 includes an intake manifold 40 (or intake system), an exhaust manifold 42 (or exhaust system), and a throttle 44. The throttle 44, compressor bypass valve 58, and wastegate 56 are the primary power controls that define the amount of oxidant/fuel delivered to the combustion chamber 34. In certain embodiments, other power controls may include variable turbine geometry or variable valve timing.

As illustrated, the system 10 also includes turbochargers 46 and heat exchangers 48 (e.g., a heat exchanger) associated with the EGR circuit 30. In certain embodiments, an e-compressor (e.g., having an electric motor coupled to a compressor) may be utilized in place of the turbocharger 46. In certain embodiments, a multi-stage turbocharging system may be utilized. Each turbocharger 46 includes a compressor 50 coupled to a turbine 52 (e.g., via a drive shaft (not shown)). Air 51 (e.g., oxidant) is provided via an intake 54. In certain embodiments, air filters may be disposed within the intake 54. The turbine 52 is driven by exhaust gas to drive the compressor 50, which in turn compresses the intake air, fuel, and EGR flow for intake into the intake manifold 40 after cooling by the heat exchangers 48. In addition, fuel 55 (e.g., hydrocarbon, hydrogen, ammonia) is supplied from a fuel supply system 53 downstream of the intake 54 and upstream of the compressor 50. As depicted, the fuel supply system 53 is a low pressure (draw-through) fuel supply system. In a low pressure (LP) fuel system, low gas pressure is utilized by mixing the gas (fuel) with air at atmospheric pressure, or slightly sub-atmospheric pressure, before the compressor 50. The air 51 and the fuel 55 may be mixed to form an intake flow 63, which is then drawn though the compressor 50 and expelled as a discharged flow 57 (e.g., compressed flow). In certain embodiments, the intake flow 63 may not include the air 51. Since the fuel mixes at ambient conditions, changes in these conditions will affect engine performance. Typical gas (fuel) pressures to the engine fuel regulator fall in the range of 0.5 to 5 psig. In certain embodiments, the fuel supply system 53 may be a high pressure (HP) fuel supply system. With a high pressure fuel system, a turbocharged engine needs gas (fuel) supply pressures to be greater than the boost pressure produced by the compressor 50. Since the fuel is introduced to the air stream after the air passes through the compressor 50, this differential pressure (i.e., gas over air pressure) allows for proper blending of the fuel and air in the carburetor. Typical gas (fuel) pressures to the engine fuel regulator fall in the range of 12 to 90 psig. In certain embodiments, the fuel supply system 53 may include a control device to regulate the air and fuel provided to the engine 12.

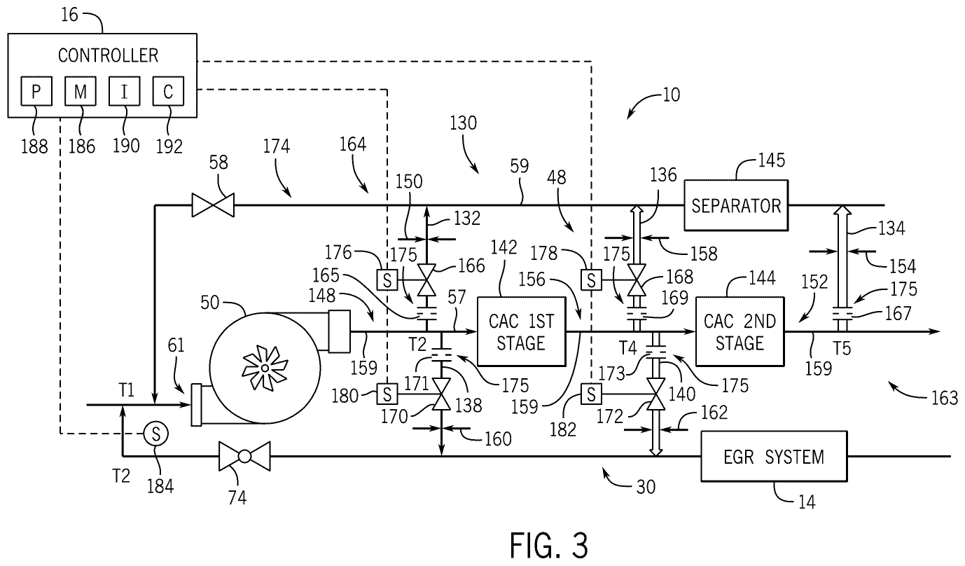

A wastegate 56 (e.g., wastegate valve) may be disposed between exhaust manifold discharge and the exhaust system to regulate the turbocharger 46 by diverting exhaust energy from the turbine 52. The wastegate 46 functionally regulates the amount of engine exhaust provided to the turbine 52 of the turbocharger 46 and thus the compressor discharge pressure produced by the compressor 50. The wastegate 56 may be of an integral type (e.g., with the turbine 52), an electronically controlled wastegate (e-wastegate), or a pneumatic wastegate that senses pressure elsewhere within the system 10. The system 10 may also include a respective compressor bypass conduit 59 (e.g., flow line, bypass line, compressor bypass line, etc.) having a bypass valve 58 (e.g., compressor bypass valve (CBV)) associated with each compressor 50 of each turbocharger 46 to control pressure by diverting a portion of the intake flow to the engine 12. In the illustrated embodiment, the compressor bypass conduit 59 is fluidly coupled to an inlet 61 of the compressor 50. As depicted the compressor bypass valve 58 is separate from the compressor 50. In certain embodiments, the compressor bypass valve 58 is integrated within the compressor 50. In certain embodiments, as described in further detail below with reference to FIGS. 3-5, one or more conduits and associated valves may be interspersed between the compressor 50 and the heat exchangers 48, wherein the one or more conduits are coupled to the compressor bypass conduit 59 and/or an exhaust gas recirculation (EGR) line to providing varying amounts of a compressor bypass flow to an inlet of the compressor 50 to help control a compressor inlet temperature and inhibit condensation at the inlet.

Disposed downstream of each turbine 52 along the EGR circuit 30 is an EGR cooler unit 60. In certain embodiments, each EGR cooler unit 60 includes multiple functional segments. As depicted, each EGR cooler unit 60 includes a high temperature non-condensing cooler 62, a low temperature condensing cooler 64, an adiabatic gas/liquid separator 66, and a reheater 68. The reheater 68 may utilize engine coolant, sometimes referred to as jacket water to heat the EGR flow to the desired temperature. Each of the high temperature non-condensing cooler 62, the low temperature condensing cooler 64, and reheater 68 may include a separate coolant line, known as an auxiliary coolant circuit, or may utilize jacket water. In addition, the high temperature non-condensing cooler 62, the low temperature condensing cooler 64, and reheater 68 may be interconnected to a hydraulic integration circuit 70, which may be part of the Balance of Plant (BoP). In certain embodiments, the EGR cooler unit 60 includes at least two of these functional sections. In certain embodiments, the EGR cooler unit 60 may include more than one of each functional section. The system 10 includes a bypass valve 72 (e.g., thermostatically controlled bypass valve) disposed between the EGR circuit 30 and the EGR cooler unit 60. The bypass valve 72 may be reacting to a local temperature or controlled by a controller 16 (e.g., via an actuator). The bypass valve 72 (e.g., when open) directs the EGR flow to the gas/liquid separator 66, thus, bypassing the coolers 62, 64.

The EGR circuit 30 of the EGR system 14 includes an EGR valve 74 disposed downstream from the exhaust manifold 42 and upstream from the compressor 50. In particular, the EGR valve 74 is located on the cold side of the respective EGR cooler unit 60 to keep it near ambient temperature. The EGR valve 74 when opened enables EGR flow to the compressor 50 and subsequently to the intake manifold 40 of the engine 12. As depicted, these EGR valves 74 are disposed in parallel relative to each other.

Although a portion of the exhaust in the circuit 30 is diverted toward the EGR cooler units 60, the remaining portion of the exhaust is diverted to an exhaust aftertreatment system 78. In certain embodiments, the exhaust aftertreatment system 78 may include a three-way catalyst to reduce exhaust emissions (e.g., nitrogen oxides (NOx), hydrocarbons (HC), carbon monoxide (CO), and other emissions).

Various components (or actuators for these components) of the system 10, the engine 12, and the EGR system 14 may be in communication with the controller 16 (e.g., electronic control unit). For example, the EGR valves 74, the throttles 44, the compressor bypass valves 58, the wastegate valves 56, the bypass valves 72, and/or the fuel supply system 53 (including the air/fuel control device) may be communicatively coupled to the controller 16 to enable the controller 16 to control these components.

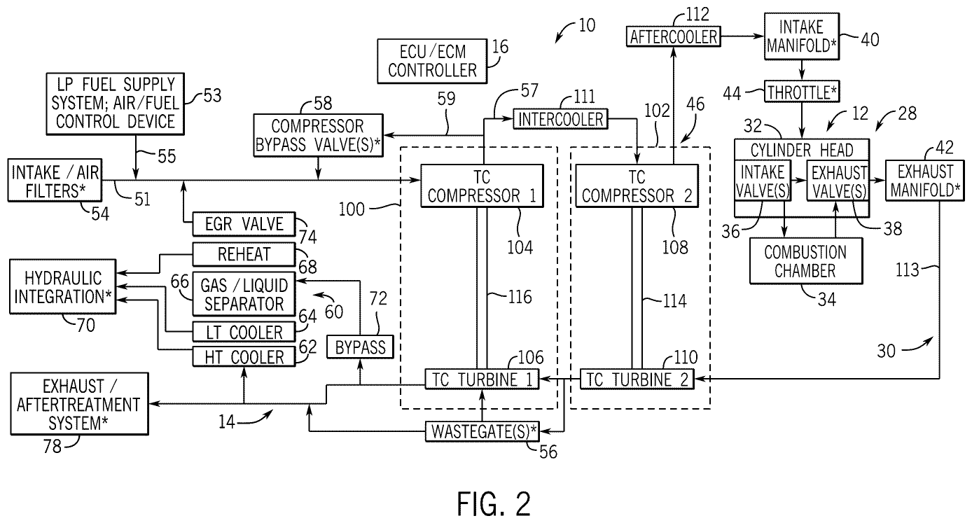

FIG. 2 is a schematic diagram of an embodiment of the engine driven power generation system 10 having a plurality of turbochargers 46 (e.g., first turbocharger 100, second turbocharger 102) in series. Otherwise, the embodiment of FIG. 2 is substantially the same as described above with reference to FIG. 1. Accordingly, like numbers are used for like elements, and the description of FIG. 1 applies to FIG. 2 unless stated otherwise. As shown, the first turbocharger 100 includes a first compressor 104 and a first turbine 106, and the second turbocharger 102 includes a second compressor 108 and a second turbine 110. As shown, the first compressor 104 receives air 51 via the intake 54 and fuel 55 from the fuel supply system 53. An heat exchanger 111 receives the discharged flow 57 (e.g., compressed air-fuel mixture) from the first compressor 104 and sends the discharged flow 57 to the second compressor 108. The discharged flow 57 is sent from the second compressor 108 to an aftercooler 112, which further cools the discharged flow 57. The discharged flow 57 is then sent to the intake manifold 40 of the engine 12. As shown, the engine 12 includes multiple cylinder banks 28 and an EGR circuit 30.

An exhaust gas flow 113 from the engine 12 is transferred through the EGR circuit 30 to the second turbine 110. The exhaust gas flow 113 causes the second turbine 110 to rotate such that the second turbine 110 drives the second compressor 108 via a shaft 114. The exhaust gas flow 113 is output from the second turbine 110 to the first turbine 108. The exhaust gas flow 113 causes the first turbine 108 to rotate such that the first turbine 108 drives the first compressor 104 via a shaft 116. The exhaust gas flow 113 is output form the first turbine 108 and is distributed to the aftertreatment system 78, or the bypass 72 and the gas/liquid separator 66.

In certain embodiments, as described in further detail below with reference to FIGS. 3-5, one or more conduits and associated valves may be interspersed between the first and second compressors 104 and 108, the heat exchanger 111, and the aftercooler 112, wherein the one or more conduits are coupled to the compressor bypass conduit 59 and/or an exhaust gas recirculation (EGR) line to providing varying amounts of a compressor bypass flow to an inlet of the first compressor 104 to help control a compressor inlet temperature and inhibit condensation at the inlet. The one or more conduits may include passive flow controls, such as conduits of different sizes, orifice plates of different sizes, or flow regulators of different sizes. Various aspects of the conduits and valves are discussed below.

FIG. 3 is a schematic diagram of an embodiment of the engine driven power generation system 10 (e.g., forced induction system) having a plurality of conduits 130 (e.g., conduits 132, 134, 136, 138, 140) interspersed between the compressor 50 and the heat exchangers 48 (e.g., heat exchangers 142, 144). In certain embodiments, the engine driven power generation system 10 may include a turbocharger system (e.g., driven by a turbine), a supercharger system (e.g., mechanically driven), or the like. In the illustrated embodiment, the heat exchanger 142 (e.g., first heat exchanger) is disposed downstream of the compressor 50, and the heat exchanger 144 (e.g., second heat exchanger) is disposed downstream of the heat exchanger 142. In certain embodiments, the heat exchanger 142 and/or the heat exchanger 144 may include an intercooler, an aftercooler, a charge air cooler (CAC), or a combination thereof. For example, the heat exchanger 142 may include a first stage of a CAC and the heat exchanger 144 may include a second stage of a CAC. The engine driven power generation system 10 also includes the compressor bypass conduit 59 having the compressor bypass valve 58 (e.g., bypass valve) and a separator 145 (e.g., gas/liquid separator). As shown, the compressor bypass conduit 59 is fluidly coupled to an inlet 61 of the compressor 50. The engine driven power generation system 10 also includes the EGR system 14 coupled to an EGR circuit 30 (e.g., EGR line) having an EGR valve 74. As shown, the EGR circuit 30 is fluidly coupled to the inlet 61 of the compressor 50. In certain embodiments, the CAC may be a liquid-cooled CAC or a gas-cooled CAC.

As shown, an outlet 148 of the compressor 50 is fluidly coupled to the compressor bypass conduit 59 via the conduit 132 (e.g., first conduit) having a first diameter 150, and an outlet 152 of the heat exchanger 144 is fluidly coupled to the compressor bypass conduit 59 via the conduit 134 (e.g., second conduit) having a second diameter 154. As shown, the first diameter 150 is different than (e.g., less than) the second diameter 154. Additionally or alternatively, an outlet 156 of the heat exchanger 142 may be fluidly coupled to the compressor bypass conduit 59 via the conduit 136 (e.g., third conduit) having a third diameter 158. As shown, the third diameter 158 is different than (e.g., greater than) the first diameter 150 and different than (e.g., less than) the second diameter 154. In the illustrated embodiment, the conduits 132, 134, 136 are coupled to conduits 159 disposed between the compressor 50 and the heat exchangers 142, 144. In certain embodiments, the conduit 132 may be directly coupled to the compressor 50, the conduit 134 may be directly coupled to the heat exchanger 144, the conduit 136 may be directly coupled to the heat exchanger 142, or a combination thereof. As shown, the separator 145 is disposed on the compressor bypass conduit 59 between the conduits 134 and 136. In certain embodiments, the conduit 134 may be omitted. In certain embodiments, a ratio between the third diameter 158 and the second diameter 154 is between 0.5 and 2, 0.7 and 1.4, or both. Additionally or alternatively, a ratio between the first diameter 150 and the second diameter 154 is between 0.5 and 2, 0.7 and 1.4, or both.

Additionally or alternatively, the outlet 148 of the compressor 50 may be fluidly coupled to the EGR circuit 30 via the conduit 138 (e.g., fourth conduit) having a fourth diameter 160. As shown, the fourth diameter 160 of the conduit 138 is different than (e.g., less than) the second diameter 154 of the conduit 134. In certain embodiments, the fourth diameter 160 may be different than (e.g., less than) the third diameter 158 of the conduit 136. Additionally or alternatively, the outlet 156 of the heat exchanger 142 may be fluidly coupled to the EGR circuit 30 via the conduit 140 (e.g., fifth conduit) having a fifth diameter 162. In certain embodiments, the fifth diameter 162 may be different than (e.g., less than) the second diameter 154 of the conduit 134 and different than (e.g., greater than) the fourth diameter 160 of the conduit 138. In the illustrated embodiment, the conduits 138, 140 are coupled to conduits 159 between the compressor 50 and the heat exchangers 142, 144. In certain embodiments, the conduit 138 may be directly coupled to the compressor 50, the conduit 140 may be directly coupled to the heat exchanger 142, or a combination thereof. In certain embodiments, a ratio between the fourth diameter 160 and the second diameter 154 is between 0.5 and 2, 0.7 and 1.4, or both. Additionally or alternatively, a ratio between the fifth diameter 162 and the second diameter 154 is between 0.5 and 2, 0.7 and 1.4, or both.

In certain embodiments, the conduits 130 may include orifice plates 163 (e.g., orifice plates 165, 167, 169, 171, 173) configured to restrict the flow of the discharged flow 57 through the orifice plates 163. The orifice plates 163 may include orifices 175 (e.g., apertures) having varying diameters. In certain embodiments, the diameters of the orifices may be different from one another. For example, a diameter of the orifice plate 165 may be smaller than a diameter of the orifice plate 169. It may be appreciated that by using orifice plates 163 having apertures of varying diameters, the diameters of the conduits 130 may be uniform. In certain embodiments, a combination of the orifice plates 163 and the conduits 130 of varying diameters may be used. In certain embodiments, the orifice plates 163 may be omitted.

In the illustrated embodiment, the engine driven power generation system 10 includes a plurality of valves 164 (e.g., valves 166, 168, 170, 172) configured to control a flow rate of the discharged flow 57 output by the compressor 50 through the plurality of conduits 130 to the compressor bypass conduit 59, the EGR circuit 30, or a combination thereof. Additionally or alternatively, the engine driven power generation system 10 includes a plurality of sensors 174 (e.g., sensors 176, 178, 180, 182) configured to monitor one or more properties (e.g., temperature, pressure, and/or flowrate) of the discharged flow 57 in the plurality of conduits 130. The engine driven power generation system 10 also includes a sensor 184 configured to monitor a temperature, a pressure, gas composition, and/or a moisture content (e.g., humidity) at the inlet 61 of the compressor 50. In certain embodiments, the flow rate of the discharged flow 57 may be controlled by switching one or more of the valves 164 from a fully open to a fully closed position. Additionally or alternatively, the flow rate of the discharged flow 57 may be controlled by

As shown, the engine driven power generation system 10 includes the controller 16. In the illustrated embodiment, the controller 16 includes a memory 186, a processor 188, instructions 190 stored in the memory 186 and executable by the processor 188, and circuitry 192. In certain embodiments, the controller 16 may be configured to monitor a temperature, a pressure, and/or a moisture content (e.g., humidity) at the inlet 61 of the compressor 50. For example, the controller 16 may be configured to receive a signal form the sensor 184 (e.g., thermocouple, resistive temperature device, etc.) disposed at the inlet 61 of the compressor 50 and/or one or more signals from the plurality of sensors 174. The controller 16 may be configured to compare the temperature with a threshold temperature. In certain embodiments, the threshold temperature may be a temperature at which condensation begins to occur (e.g., dew point temperature). In certain embodiments, the threshold temperature may include a single temperature and/or a range of temperatures. It may be noted that any discussion herein regarding comparing the temperature to the threshold temperature may additionally include monitoring other quantities (e.g., pressure, moisture content, etc.).

The controller 16 may be configured to monitor the temperature at the plurality of conduits 130 and the temperature at the inlet 61 of the compressor 50, and selectively control a combination of the valves 164 based on the comparison of these temperatures with the threshold temperature in order to either increase or decrease the temperature at the inlet 61. For example, the controller 16 may be configured to control the valve 166 (e.g., first valve) to adjust a flowrate of the discharged flow 57 from the outlet 148 of the compressor 50 to the compressor bypass conduit 59 through the conduit 132 based on the comparison. Additionally or alternatively, the controller 16 may be configured to control the valve 168 (e.g., second valve) to adjust a flowrate of the discharged flow 57 from the outlet 156 of the first heat exchanger 142 to the compressor bypass conduit 59 through the third conduit 136 based on the comparison. Additionally or alternatively, the controller 16 may be configured to control the valve 170 (e.g., third valve) to adjust a flowrate of the discharged flow 57 from the outlet 148 of the compressor 50 to the EGR circuit 30 through the fourth conduit 138 based on the comparison. Additionally or alternatively, the controller 16 may be configured to control the valve 172 (e.g., fourth valve) to adjust a flowrate of the discharged flow 57 from the outlet 156 of the first heat exchanger 142 to the EGR circuit 30 through the fifth conduit 140 based on the comparison. In certain embodiments, the controller 16 may be configured to control the valves 164 independently from each other.

In certain embodiments, a temperature (T1) of the air 51 and/or fuel 55 entering the compressor 50 is between- 40 degrees Celsius and 40 degrees Celsius. Additionally or alternatively, a temperature (T2) of the exhaust gas flow 113 in the EGR circuit 30 may be between 60 degrees Celsius and 85 degrees Celsius. Additionally or alternatively, a temperature (T3) of the discharged flow 57 at the outlet 148 of the compressor 50 may be between 200 degrees Celsius and 300 degrees Celsius (e.g., engine at full power or extreme conditions) or may be between 110 degrees Celsius and 225 degrees Celsius (e.g., lightly loaded conditions). Additionally or alternatively, a temperature (T4) of the discharged flow 57 at the outlet 156 of the first heat exchanger 142 may be between 40 degrees Celsius and 100 degrees Celsius. Additionally or alternatively, a temperature (T5) of the discharged flow 57 at the outlet 152 of the second heat exchanger 144 may be between 30 degrees Celsius and 60 degrees Celsius.

It may be appreciated that the different dimensions of the diameters of the conduits 130 may provide a predetermined proportionality on the resulting mixed gas flow 194 in the compressor bypass conduit 59, thereby enabling target temperatures of the mixed gas flow 194 to be between T3 and T5 with minimal costs. That is, the conduits 130 having different temperatures may be proportionally mixed based at least in part on the differing diameters of the conduits 130. However, the conduits 130 may include a variety of passive flow control features based on different flow geometries, such as different cross-sectional areas of flow paths through the conduits 130, orifice plates having one or more orifices, flow restrictions, flow regulators, chokes, or the like.

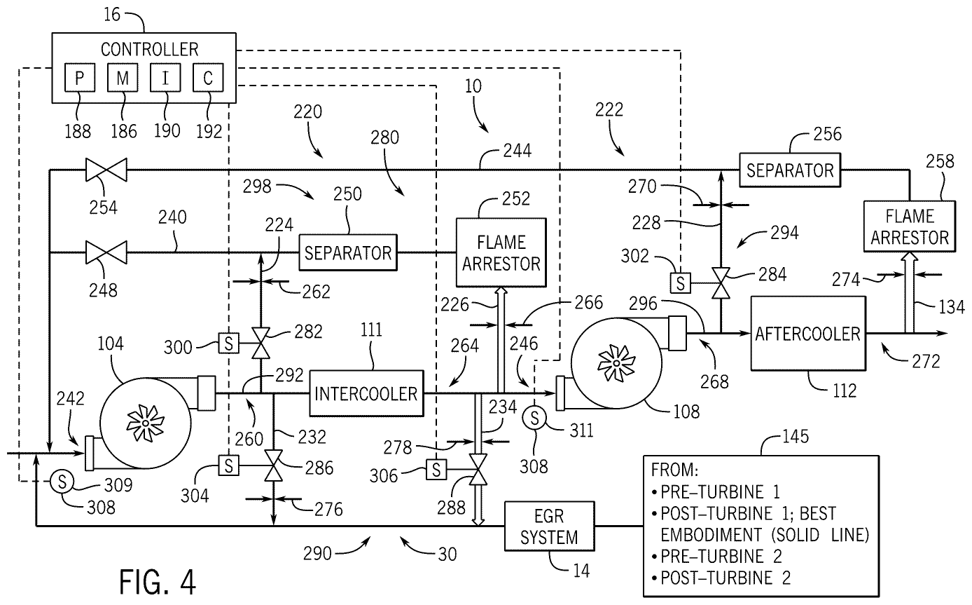

FIG. 4 is a schematic diagram of an embodiment of the engine driven power generation system 10 having a plurality of compressors 220 (e.g., compressors 104, 108) and a plurality of conduits 222 (e.g., conduits 224, 226, 228, 230, 232, 234) interspersed between the plurality of compressors 220. In the illustrated embodiment, the engine driven power generation system 10 includes the heat exchanger 111 disposed downstream of the compressor 104 (e.g., first compressor). The compressor 108 (e.g., second compressor) is disposed downstream of the heat exchanger 111, and the aftercooler 112 is disposed downstream of the compressor 108. The engine driven power generation system 10 includes a first compressor bypass conduit 240 fluidly coupled to an inlet 242 of the compressor 104 and fluidly coupled to the heat exchanger 111, and a second compressor bypass conduit 244 fluidly coupled to an inlet 246 of the compressor 108 and fluidly coupled to the aftercooler 112. The engine driven power generation system 10 also includes the EGR system 14 having the EGR circuit 30. As shown, the EGR circuit 30 is fluidly coupled to the inlet 242 of the compressor 104. The EGR circuit 30 may also be fluidly coupled to a location upstream and/or downstream of either the first and/or second turbines.

In the illustrated embodiment, the first compressor bypass conduit 240 includes a first compressor bypass valve 248, a first separator 250 (e.g., gas/liquid separator), and a first flame arrestor 252. The first separator 250 may be configured to separate a liquid from a gas flowing through the bypass line 240. The second compressor bypass conduit 244 includes a second compressor bypass valve 254, a second separator 256, and a second flame arrestor 258. The second separator 256 may be configured to separate a liquid from a gas flowing through the bypass line 244. In the illustrated embodiment, the second compressor bypass conduit 244 is directly and fluidly coupled to the first compressor bypass conduit 240. In certain embodiments, the first compressor bypass conduit 240 and the second compressor bypass conduit 244 may not be directly coupled to one another. In certain embodiments, the first flame arrestor 252 and/or the second flame arrestor 258 may be disposed in flanges of the first compressor bypass conduit 240 and the second compressor bypass conduit 244. In certain embodiments, the first separator 250 and/or the second separator 256 may include a coalescing separator, a vane separator, a gravity separator, a centrifugal separator, or the like. In certain embodiments, the first flame arrestor 252 and/or the second flame arrestor 258 may block a transmission of a flame through a flammable gas/air mixture by quenching the flame on a high surface area by an array of passages through which the flame must pass.

As shown, an outlet 260 of the compressor 104 is fluidly coupled to the first compressor bypass conduit 240 via the conduit 224 (e.g., first conduit) having a first diameter 262, and an outlet 264 of the heat exchanger 111 is fluidly coupled to the first compressor bypass conduit 240 via the conduit 226 (e.g., second conduit) having a second diameter 266. As shown, the first diameter 262 is different than (e.g., less than) the second diameter 266. As shown, the conduit 226 is fluidly coupled to the first flame arrestor 252. Additionally or alternatively, an outlet 268 of the compressor 108 is fluidly coupled to the second compressor bypass conduit 244 via the conduit 228 (e.g., third conduit) having a third diameter 270, and an outlet 272 of the aftercooler 238 is fluidly coupled to the second compressor bypass conduit 244 via the conduit 230 (e.g., fourth conduit) having a fourth diameter 274. As shown, the third diameter 270 is different than (e.g., less than) the fourth diameter 274. As shown, the conduit 230 is fluidly coupled to the second flame arrestor 258. Additionally or alternatively, the outlet 260 of the compressor 104 is fluidly coupled to the EGR circuit 30 via the conduit 232 (e.g., fifth conduit) having a fifth diameter 276, and the outlet 264 of the heat exchanger 111 is fluidly coupled to the EGR circuit 30 via the conduit 234 (e.g., sixth conduit) having a sixth diameter 278. As shown, the fifth diameter 276 is different than (e.g., less than) the second diameter 266. In certain embodiments, the sixth diameter 278 may be different than (e.g., less than) the second diameter 266.

In the illustrated embodiment, the engine driven power generation system 10 includes a plurality of valves 280 (e.g. valves 282, 284, 286, 288) configured to control a flow rate of portions 290 of a discharged flow 292 output from the compressor 104 and/or a portion 294 of a discharged flow 296 output from the compressor 108. Additionally or alternatively, the engine driven power generation system 10 includes a plurality of sensors 298 (e.g., sensors 300, 302, 304, 306) configured to monitor one or more properties (e.g., temperature, pressure, and/or flowrate) of the discharged flows 292, 296 in the plurality of conduits 222. The engine driven power generation system 10 also includes sensors 308 (e.g., sensors 309, 311) configured to monitor a temperature, pressure, gas composition, and/or moisture content (e.g., humidity) at the inlet 242 of the compressor 104 and/or the inlet 246 of the compressor 108.

As shown, the engine driven power generation system 10 includes the controller 16. In the illustrated embodiment, the controller 16 includes the memory 186, the processor 188, instructions 190 stored in the memory 186 and executable by the processor 188, and the circuitry 192. In certain embodiments, the controller 16 may be configured to monitor a temperature at the inlet 242 of the compressor 104 and/or a temperature at an inlet 246 of the compressor 108 via the sensors 308. For example, the controller 16 may be configured to receive a signal from the sensor 309 (e.g., thermocouple, resistive temperature device, etc.) disposed at the inlet 242 of the compressor 104 and/or the sensor 311 disposed at the inlet 246 of the compressor 108. The controller 16 may be configured to compare the temperature with a temperature threshold. In certain embodiments, the threshold temperature may include a single temperature and/or a range of temperatures. In certain embodiments, the threshold temperature may be a temperature at which condensation begins to occur (e.g., dew point temperature). In certain embodiments, the threshold temperature may include a single temperature and/or a range of temperatures. It may be noted that any discussion herein regarding comparing the temperature to the threshold temperature may additionally include monitoring other quantities (e.g., pressure, moisture content, etc.). Additionally or alternatively, the controller 16 may be configured to monitor flowrates and/or temperatures via the sensors 298.

The controller 16 may be configured to control a combination of the valves 280 based on the comparison of the temperature with the threshold temperature. For example, the controller 16 may be configured to control the valve 282 to adjust a flowrate of the discharged flow 292 from the outlet 260 of the compressor 104 to the first compressor bypass conduit 240 through the conduit 224 based on the comparison. Additionally or alternatively, the controller 16 may be configured to control the valve 284 to adjust a flowrate of the discharged flow 294 from the outlet 268 of the compressor 108 to the second compressor bypass conduit 244 through the conduit 228 based on the comparison. Additionally or alternatively, the controller 16 may be configured to control the valve 286 to adjust a flowrate of the discharged flow 292 from the outlet 260 of the compressor 104 to the EGR circuit 30 through the conduit 232 (e.g., fifth conduit) based on the comparison. Additionally or alternatively, the controller 16 may be configured to control the valve 288 to adjust a flowrate of the discharged flow 292 from the outlet 264 of the heat exchanger 111 to the EGR circuit 30 through the conduit 234 (e.g., sixth conduit) based on the comparison. In certain embodiments, the controller 16 may be configured to control the valves 222 independently from each other.

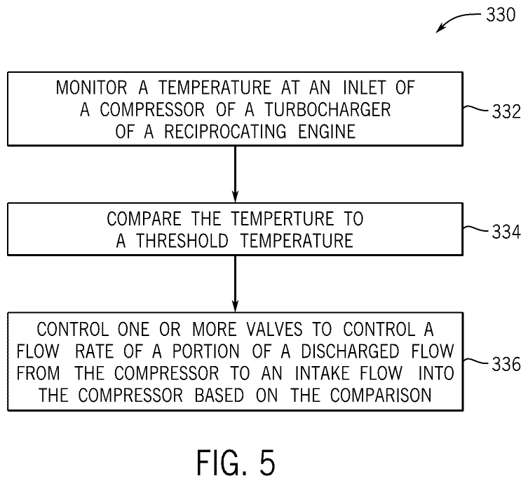

FIG. 5 is a flowchart of an example process 330 of operating the engine driven power generation system 10. The blocks of the process 330 may be executed by the controller 16 and/or another suitable controller or computer. The blocks of the process 330 may be performed in the order disclosed herein or in any other suitable order. For example, certain blocks of the process 330 may be performed concurrently. In addition, in certain embodiments, at least one of the blocks of the process 330 may be omitted.

In block 332 of the process 330, the controller 16 may monitor a temperature, pressure, gas composition, and/or moisture content (e.g., humidity) of a received intake flow at an inlet (e.g., inlets 61, 242, 246) of a compressor (e.g., compressor 50, 104, 108) of the engine driven power generation system. For example, the controller 16 may receive one or more signals from one or more sensors (e.g., sensors 184, 309, 311) indicative of the temperature of the intake flow 63 entering the compressor.

In block 334 of the process 330, the controller 16 may compare the temperature of the intake flow 63 at the inlet of the compressor to a threshold temperature value. In certain embodiments, the threshold temperature value may include a single value or a range of temperature values. In certain embodiments, the threshold temperature may be a temperature at which condensation begins to occur (e.g., dew point temperature). Additionally or alternatively, the controller 16 may monitor a pressure, gas composition, and/or moisture content (e.g., humidity) and may determine the threshold temperature at least partially based on these quantities. The controller 16 may determine whether the temperature received from the one or more sensors is greater than or less the threshold temperature value.

In block 336 of the process 330, the controller 16 may control one or more valves (e.g., valves 164, 280) to control a flow rate of a portion of a discharged flow (e.g., discharged flows 57, 292, 296) from the compressor to the intake flow 63 into the compressor based on the comparison between the temperature and the temperature threshold value. In certain embodiments, if the temperature is greater than or less than the threshold temperature value, the controller 16 may control the valves to adjust a flow rate of the portion of the discharged flow through a combination of the plurality of conduits (e.g., plurality of conduits 130, 222). For example, the controller 16 may control the valve 166 (e.g., first valve) to adjust a flow rate of a first portion a discharged flow 57 from the outlet 148 of the compressor 50 to the compressor bypass conduit 59 through the conduit 132 (e.g., first conduit) based on a comparison of the temperature and the temperature threshold value. In certain embodiments, the controller 16 may control the one or more valves to oscillate (e.g., dither) between a first position and a second position at a given frequency. Additionally or alternatively, the controller 16 may control the one or more valves to oscillate between the first position and the second position via pulse width modulation (PWM).

Technical effects of the disclosed embodiments include monitoring a temperature of an intake flow to a compressor and comparing the temperature to a threshold temperature value. Based on the comparison, one or more valves may be adjusted to control a flow rate of a portion of a discharged flow from the compressor along one or more conduits coupled to a compressor bypass conduit and/or an exhaust gas recirculation (EGR) line, which are fluidly coupled to an intake flow path into the compressor inlet. It may be appreciated that by adjusting the temperature of the flow in the compressor bypass conduit and/or the EGR line, the disclosed embodiment may substantially reduce or eliminate potential condensation at the inlet of the compressor. In certain embodiments, the one or more conduits may include a variety of passive flow control features based on different flow geometries, such as different cross-sectional areas of flow paths through the conduits, orifice plates having one or more orifices, flow restrictions, flow regulators, chokes, or the like.

The subject matter described in detail above may be defined by one or more clauses, as set forth below.

According to a first aspect, a system includes a forced induction system configured to couple to a reciprocating engine. The forced induction system includes a compressor and a first heat exchanger disposed downstream of the compressor. The forced induction system also includes a compressor bypass conduit configured to direct a compressor bypass flow from a bypass location disposed downstream from the first heat exchanger to a return location upstream from the compressor. The forced induction system also includes a first conduit configured to direct a first portion of a compressor discharge flow from a first location between the compressor and the first heat exchanger to the compressor bypass conduit. The first portion of the compressor discharge flow is configured to add heat to the compressor bypass flow to increase a temperature at an inlet of the compressor.

The system of the preceding clause, wherein the first conduit includes a passive flow control configured to regulate the first portion of the compressor discharge flow.

The system of any preceding clause, wherein the passive flow control includes a diameter or cross-sectional area of the first conduit, an orifice plate, or a combination thereof.

The system of any preceding clause, wherein the first conduit includes a first valve configured to regulate the first portion of the compressor discharge flow.

The system of any preceding clause, including: one or more sensors disposed along the compressor bypass conduit, the first conduit, or in fluid communication with the inlet of the compressor, wherein the one or more sensors are configured to monitor a temperature; and a controller having a processor, a memory, and instructions stored on the memory and executable by the processor to: monitor the temperature via the one or more sensors; compare the temperature with a threshold temperature; and control the first valve to regulate the first portion of the compressor discharge flow based on the comparison.

The system of any preceding clause, wherein the controller is configured to control the first valve via a dither signal.

The system of any preceding clause, including a second heat exchanger disposed downstream of the first heat exchanger, wherein the compressor bypass conduit is configured to direct the compressor bypass flow from the bypass location disposed downstream from the first and second heat exchangers to the return location upstream from the compressor; and a second conduit configured to direct a second portion of the compressor discharge flow from a second location between the first and second heat exchangers to the compressor bypass conduit, wherein the second portion of the compressor discharge flow is configured to add heat to the compressor bypass flow to increase the temperature at the inlet of the compressor.

The system of any preceding clause, including a third conduit configured to direct a third portion of the compressor discharge flow from a third location downstream of the second heat exchanger to the compressor bypass conduit, wherein the third portion of the compressor discharge flow is configured to add heat to the compressor bypass flow to increase the temperature at the inlet of the compressor, wherein a ratio between a second diameter of the second conduit and a third diameter of the third conduit is between 0.5 and 2.

The system of any preceding clause, wherein a first temperature of the compressor discharge flow at an outlet of the compressor is between 200 degrees Celsius and 300 degrees Celsius, a second temperature of the compressor discharge flow at a first heat exchanger outlet of the first heat exchanger is between 40 degrees Celsius and 100 degrees Celsius, a third temperature of the compressor discharge flow at a second heat exchanger outlet of the second heat exchanger is between 30 degrees Celsius and 60 degrees Celsius.

The system of any preceding clause, wherein the first and second conduits are configured to direct different flow rates of the first and second portions of the compressor discharge flow via one or more passive flow controls, valves, or a combination thereof.

The system of any preceding clause, including an exhaust gas recirculation (EGR) system having an EGR conduit extending to an EGR location upstream from the compressor.

The system of any preceding clause, including one or more conduits configured to direct at least a portion of the compressor discharge flow from one or more locations downstream from the compressor and upstream from the second heat exchanger to the EGR conduit, wherein the portion of the compressor discharge flow is configured to adjust the temperature at the inlet of the compressor.

The system of any preceding clause, wherein the one or more conduits include a passive flow control configured to regulate the portion of the compressor discharge flow.

The system of any preceding clause, wherein the passive flow control includes a diameter or cross-sectional area of the one or more conduits, an orifice plate, or a combination thereof, wherein the one or more conduits include at least one valve configured to regulate the portion of the compressor discharge flow.

According to a second aspect, a system includes a forced induction system configured to couple to a reciprocating engine. The forced induction system includes a compressor and a first heat exchanger disposed downstream of the compressor. The forced induction system also includes a compressor bypass conduit configured to direct a compressor bypass flow from a bypass location disposed downstream from the first heat exchanger to a return location upstream from the compressor. The forced induction system also includes an exhaust gas recirculation (EGR) conduit extending to an EGR location upstream from the compressor. The forced induction system also includes one or more first conduits configured to direct a first portion of a compressor discharge flow from one or more first locations between the compressor and the first heat exchanger to the compressor bypass conduit, the EGR conduit, or a combination thereof. The first portion of the compressor discharge flow is configured to adjust a temperature at an inlet of the compressor.

The system of the preceding clause, wherein the one or more first conduits includes one or more passive flow controls, valves, or a combination thereof, to regulate the first portion of the compressor discharge flow.

The system of any preceding clause, including one or more valves configured to regulate the first portion of the compressor discharge flow through the one or more first conduits; one or more sensors disposed along the compressor bypass conduit, the EGR conduit, or in fluid communication with the inlet of the compressor, wherein the one or more sensors are configured to monitor a temperature; and a controller having a processor, a memory, and instructions stored on the memory and executable by the processor to: monitor the temperature via the one or more sensors; compare the temperature with a threshold temperature; and control the one or more valves to regulate the first portion of the compressor discharge flow based on the comparison.

The system of any preceding clause, including: a second heat exchanger disposed downstream of the first heat exchanger, wherein the compressor bypass conduit is configured to direct the compressor bypass flow from the bypass location disposed downstream from the first and second heat exchangers to the return location upstream from the compressor; and one or more second conduits configured to direct a second portion of the compressor discharge flow from one or more second locations between the first and second heat exchangers to the compressor bypass conduit, the EGR conduit, or a combination thereof, wherein the second portion of the compressor discharge flow is configured to adjust the temperature at the inlet of the compressor.

According to a third aspect, a method includes directing a compressor bypass flow from a bypass location disposed downstream from an heat exchanger to a return location upstream from a compressor of a turbocharger. The method also includes directing a first portion of a compressor discharge flow output by the compressor from a first location between the compressor and the heat exchanger to the compressor bypass conduit. The first portion of the compressor discharge flow is configured to add heat to the compressor bypass flow to increase a temperature at an inlet of the compressor.

The method of the preceding clause, including directing the compressor bypass flow from the bypass location disposed downstream from the first heat exchanger and a second heat exchanger to the return location upstream from the compressor. The second heat exchanger is disposed downstream from the first heat exchanger.

This written description uses examples to disclose the subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] ... ” or “step for [perform]ing [a function] ... ”, it is intended that such elements are to be interpreted under 35 U.S.C. 112(f). However, for any claims containing elements designated in any other manner, it is intended that such elements are not to be interpreted under 35 U.S.C. 112 (f).

1. A system, comprising:
a forced induction system configured to couple to a reciprocating engine, wherein the forced induction system comprises:
a compressor;
a first heat exchanger disposed downstream of the compressor;
a compressor bypass conduit configured to direct a compressor bypass flow from a bypass location disposed downstream from the first heat exchanger to a return location upstream from the compressor;
a first conduit configured to direct a first portion of a compressor discharge flow from a first location between the compressor and the first heat exchanger to the compressor bypass conduit;
a valve disposed along the first conduit, wherein the valve is configured to regulate the first portion of the compressor discharge flow; and
a controller having a memory and one or more processors, wherein the controller is configured to control the valve, to add heat to the compressor bypass flow via the first portion of the compressor discharge flow to increase a temperature at an inlet of the compressor.

2. The system of claim 1, wherein the first conduit comprises a passive flow control configured to regulate the first portion of the compressor discharge flow.

3. The system of claim 2, wherein the passive flow control comprises a diameter or cross-sectional area of the first conduit, an orifice plate, or a combination thereof.

4. (canceled)

5. The system of claim 1, comprising:
one or more sensors disposed along the compressor bypass conduit, the first conduit, or in fluid communication with the inlet of the compressor, wherein the one or more sensors are configured to monitor an additional temperature;
wherein the controller is configured to:
monitor the additional temperature via the one or more sensors;
compare the additional temperature with a threshold temperature; and
control the valve to regulate the first portion of the compressor discharge flow based on the comparison.

6. The system of claim 5, wherein the controller is configured to control the valve via a dither signal.

7. The system of claim 1, comprising:
a second heat exchanger disposed downstream of the first heat exchanger, wherein the compressor bypass conduit is configured to direct the compressor bypass flow from the bypass location disposed downstream from the first and second heat exchangers to the return location upstream from the compressor; and
a second conduit configured to direct a second portion of the compressor discharge flow from a second location between the first and second heat exchangers to the compressor bypass conduit, wherein the second portion of the compressor discharge flow is configured to add heat to the compressor bypass flow to increase the temperature at the inlet of the compressor.

8. The system of claim 7, comprising a third conduit configured to direct a third portion of the compressor discharge flow from a third location downstream of the second heat exchanger to the compressor bypass conduit, wherein the third portion of the compressor discharge flow is configured to add heat to the compressor bypass flow to increase the temperature at the inlet of the compressor, wherein a ratio between a second diameter of the second conduit and a third diameter of the third conduit is between 0.5 and 2.

9. The system of claim 7, wherein a first temperature of the compressor discharge flow at an outlet of the compressor is between 200 degrees Celsius and 300 degrees Celsius, a second temperature of the compressor discharge flow at a first heat exchanger outlet of the first heat exchanger is between 40 degrees Celsius and 100 degrees Celsius, a third temperature of the compressor discharge flow at a second heat exchanger outlet of the second heat exchanger is between 30 degrees Celsius and 60 degrees Celsius, or a combination thereof.

10. The system of claim 9, wherein the first and second conduits are configured to direct different flow rates of the first and second portions of the compressor discharge flow via one or more passive flow controls, one or more additional valves, or a combination thereof.

11. The system of claim 7, comprising an exhaust gas recirculation (EGR) system having an EGR conduit extending to an EGR location upstream from the compressor.

12. The system of claim 11, comprising one or more conduits configured to direct at least a portion of the compressor discharge flow from one or more locations downstream from the compressor and upstream from the second heat exchanger to the EGR conduit, wherein the portion of the compressor discharge flow is configured to adjust the temperature at the inlet of the compressor.

13. The system of claim 12, wherein the one or more conduits comprise a passive flow control configured to regulate the portion of the compressor discharge flow.

14. (canceled)

15. A system, comprising:
a forced induction system configured to couple to a reciprocating engine, wherein the forced induction system comprises:
a compressor;
a first heat exchanger disposed downstream of the compressor;
a compressor bypass conduit configured to direct a compressor bypass flow from a bypass location disposed downstream from the first heat exchanger to a return location upstream from the compressor;
an exhaust gas recirculation (EGR) conduit extending to an EGR location upstream from the compressor;
one or more first conduits configured to direct a first portion of a compressor discharge flow from one or more first locations between the compressor and the first heat exchanger to the compressor bypass conduit, the EGR conduit, or a combination thereof;
one or move valves disposed along the one or more first conduits, wherein the one or more valves are configured to regulate the first portion of the compressor discharge flow; and
a controller having a memory and one or more processors, wherein the controller is configured to control the one or more valves to adjust a temperature at an inlet of the compressor.

16. (canceled)

17. The system of claim 15, comprising:
one or more sensors disposed along the compressor bypass conduit, the EGR conduit, or in fluid communication with the inlet of the compressor, wherein the one or more sensors are configured to monitor an additional temperature;
wherein the controller is configured to:
monitor the additional temperature via the one or more sensors;
compare the additional temperature with a threshold temperature; and
control the one or more valves to regulate the first portion of the compressor discharge flow based on the comparison.

18. The system of claim 15, comprising:
a second heat exchanger disposed downstream of the first heat exchanger, wherein the compressor bypass conduit is configured to direct the compressor bypass flow from the bypass location disposed downstream from the first and second heat exchangers to the return location upstream from the compressor; and
one or more second conduits configured to direct a second portion of the compressor discharge flow from one or more second locations between the first and second heat exchangers to the compressor bypass conduit, the EGR conduit, or a combination thereof, wherein the second portion of the compressor discharge flow is configured to adjust the temperature at the inlet of the compressor.

19. A method, comprising:
directing a compressor bypass flow from a bypass location disposed downstream from a first heat exchanger to a return location upstream from a compressor of a turbocharger;
directing a portion of a compressor discharge flow output by the compressor from a first location between the compressor and the first heat exchanger to a compressor bypass conduit, wherein the portion of the compressor discharge flow is configured to add heat to the compressor bypass flow to increase a temperature at an inlet of the compressor; and
directing the compressor bypass flow from the bypass location disposed downstream from the first heat exchanger and a second heat exchanger to the return location upstream from the compressor, wherein the second heat exchanger is disposed downstream from the first heat exchanger.

20. (canceled)

21. The system of claim 15, comprising:
a second heat exchanger disposed downstream of the first heat exchanger; and
a second conduit configured to direct a second portion of the compressor discharge flow from a second location between the first and second heat exchangers to the compressor bypass conduit.

22. The system of claim 21, wherein the compressor bypass conduit is configured to direct the compressor bypass flow from the bypass location disposed downstream from the first and second heat exchangers to the return location upstream from the compressor.

23. The system of claim 22, wherein the second portion of the compressor discharge flow is configured to add heat to the compressor bypass flow to increase the temperature at the inlet of the compressor.

24. The system of claim 15, wherein the controller is configured to control the one or more valves to move between an open configuration and a closed configuration via a pulse width modulation (PWM) signal.
